(19) United States
(12) Patent Application Publication
(10) Pub. No.: US 2020/0307806 A1
(43) Pub. Date: Oct. 1, 2020

(54) SEAT ADJUSTMENT SYSTEM AND METHOD

(71) Applicant: THE BOEING COMPANY, Chicago, IL (US)

(72) Inventors: Paul W. Wilcynski, Seattle, WA (US); Martin C. Adams, Everett, WA (US)

(73) Assignee: THE BOEING COMPANY, Chicago, IL (US)

(21) Appl. No.: 16/365,788

(22) Filed: Mar. 27, 2019

(51) Int. Cl. B64D 11/06

(52) U.S. Cl. CPC B64D 11/0696; B64D 11/0639

(57) ABSTRACT

A seat adjustment system includes a seat assembly having at least one securing stud that is configured to be retained within a track channel of a seat track, and a seat adjuster coupled to the seat assembly. The seat adjuster is moveable between a secured position in which the securing stud(s) is configured to be retained within the track channel of the seat track, and an adjustment position in which the securing stud(s) is configured to be outside of the seat track.

### FIELD OF EMBODIMENTS OF THE DISCLOSURE

Embodiments of the present disclosure generally relate to seat adjustment systems and methods, and more particularly, to seat adjustment systems and methods that allow for efficient adjustment of seats within an internal cabin of a vehicle.

### BACKGROUND OF THE DISCLOSURE

Commercial aircraft typically include an internal cabin that may be divided into numerous sections. A cockpit is generally separated from a passenger cabin, which may include a first class section, a business class section, an economy section, and the like. Each section within a passenger cabin may have a different spacing or pitch between rows of seats. For example, a first class section typically has a greater pitch between rows of seats as compared to an economy section.

Between flights of an aircraft, an operator may decide to reconfigure certain seating areas to adjust the pitch between certain rows of seats. For example, an operator may decide to change a row of an economy section into an economy plus section, or vice versa. The pitch between rows of the economy section may differ from the pitch between rows of the economy plus section.

In order to change the pitch between rows of seats, the seats of at least one of the rows are completely removed and lifted from seat tracks. The seats are then moved to a new position, where they are secured to the seat tracks. Aircraft mechanics typically use tools to remove the seats from the seat tracks, reposition and align the seats in relation to the new positions, and securely lock the seats in the new positions. Moreover, any electrical connections within the seats are typically disconnected before the seats are moved, and then reconnected at the new positions.

As can be appreciated, the process of removing the seats from the seat tracks, moving the seats to new positions, and securing the seats at the new positions is time and labor intensive. If there is a relatively short time until a subsequent flight, there may not be sufficient time to adjust the seats to new positions.

### SUMMARY OF THE DISCLOSURE

A need exists for an efficient system and method for moving seats within an internal cabin of an aircraft. Further, a need exists for a system and method that allow for quick and efficient adjustment of seats within an internal cabin.

With those needs in mind, certain embodiments of the present disclosure provide a seat adjustment system that includes a seat assembly having at least one securing stud that is configured to be retained within a track channel of a seat track, and a seat adjuster coupled to the seat assembly. The seat adjuster is moveable between a secured position in which the securing stud(s) is configured to be retained within the track channel of the seat track, and an adjustment position in which the securing stud(s) is configured to be outside of the seat track. The securing stud(s) may extend downwardly from at least one leg of the seat assembly.

In at least one embodiment, the seat adjuster is pivotally coupled to the seat assembly. For example, the seat adjuster may be pivotally coupled to a bracket that extends from a lower end of the leg.

In at least one embodiment, the seat adjuster includes a pivot beam pivotally coupled to the seat assembly, a wheel rotatably coupled to the pivot beam via a wheel axle, and a lever arm connected to the pivot beam. The wheel is retained within a wheel channel of a wheel track when the seat adjuster is in the adjustment position. The wheel is disposed above the wheel track when the seat adjuster is in the secured position. The wheel track extends along at least a portion of a length of the seat track. The wheel track is secured to one or both of the seat track or a floor panel. In at least one embodiment, the lever arm is configured to be radially pivoted over a ninety degree radial range to move the seat adjuster between the secured position and the adjustment position.

In at least one embodiment, the securing stud(s) is shifted to an expanded opening within the seat track before the seat adjuster is moved to the adjustment position.

Certain embodiments of the present disclosure provide a seat adjustment method that includes providing a seat assembly having at least one securing stud that is configured to be retained within a track channel of a seat track, coupling a seat adjuster to the seat assembly, and moving the seat adjuster between a secured position in which the securing stud(s) is retained within the track channel of the seat track, and an adjustment position in which the securing stud(s) is outside of the seat track. In at least one embodiment, the coupling includes pivotally coupling the seat adjuster to the seat assembly.

In at least one embodiment, the coupling includes pivotally coupling a pivot beam of the seat adjuster to the seat assembly, rotatably coupling a wheel to the pivot beam via a wheel axle, and connecting a lever arm to the pivot beam. The seat adjustment method may also include retaining the wheel within a wheel channel of a wheel track when the seat adjuster is in the adjustment position, and disposing the wheel above the wheel track when the seat adjuster is in the secured position.

In at least one embodiment, the seat adjustment method includes shifting the securing stud(s) to an expanded opening within the seat track before the seat adjuster is moved to the adjustment position.

Certain embodiments of the present disclosure provide a vehicle including an internal cabin, first and second floor panels within the internal cabin, a seat track extending between the first floor panel and the second floor panel (wherein the seat track includes a track channel), a wheel track having a wheel channel coupled to one or both of the first floor panel or the seat track, and a seat adjustment system, as described herein.

### BRIEF DESCRIPTION OF THE DRAWINGS

FIG. 1 illustrates a perspective front view of an aircraft, according to an embodiment of the present disclosure.

FIG. 2A illustrates a top plan view of an internal cabin of an aircraft, according to an embodiment of the present disclosure.

FIG. 2B illustrates a top plan view of an internal cabin of an aircraft, according to an embodiment of the present disclosure.

FIG. 3 illustrates a side view of a seat assembly, according to an embodiment of the present disclosure.

FIG. 4 illustrates a perspective side view of legs of a seat assembly securely coupled to a seat track, according to an embodiment of the present disclosure.

FIG. 5 illustrates a perspective top view of a seat track secured between floor panels, according to an embodiment of the present disclosure.

FIG. 6 illustrates an end view of a seat adjustment system having a seat adjuster in a secured position, according to an embodiment of the present disclosure.

FIG. 7 illustrates a perspective side view of legs of a seat assembly uncoupled from the seat track, according to an embodiment of the present disclosure.

FIG. 8 illustrates an end view of the seat adjustment system having the seat adjuster in an adjustment position, according to an embodiment of the present disclosure.

FIG. 9 illustrates a flow chart of a seat adjustment method, according to an embodiment of the present disclosure.

### DETAILED DESCRIPTION OF THE DISCLOSURE

The foregoing summary, as well as the following detailed description of certain embodiments, will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide seat adjustment systems and methods that include a seat adjuster, which may include a lever coupled to a wheel. The lever is engaged to pivot the wheel into a wheel track, which allows a seat assembly to be slidably adjusted over a seat track. The wheel allows the seat assembly to be smoothly and easily slid to a desired position.

Certain embodiments of the present disclosure provide a seat adjustment system that includes a guide member, such as a wheel track, that is configured to receive a portion of an aircraft seat, such as a securing stud. The guide member has a length direction parallel to a length direction of an adjacent seat track. The guide member is affixed to one or both of an adjacent seat panel and/or the seat track.

Certain embodiments of the present disclosure provide a method of adjusting an aircraft seat that includes disengaging at least one seat track fitting from at least one seat track, supporting the seat via a guide member such that the guide member supports the weight of the seat, translating the seat along a length direction of the guide member, and engaging the at least one seat track fitting with the at least one seat track.

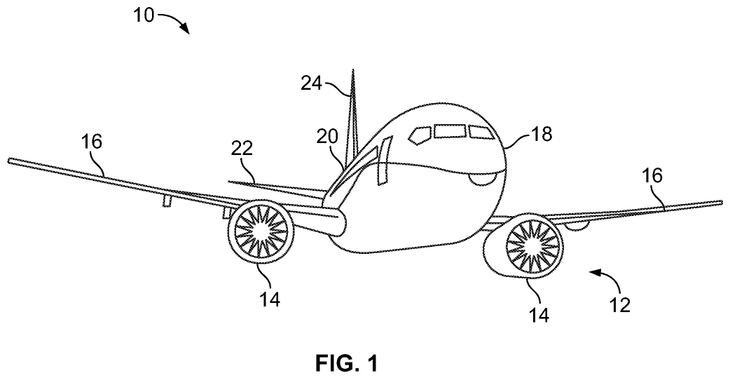

FIG. 1 illustrates a perspective top view of a vehicle, such as an aircraft 10, according to an embodiment of the present disclosure. The aircraft 10 includes a propulsion system 12 that may include two turbofan engines 14, for example. Optionally, the propulsion system 12 may include more engines 14 than shown. The engines 14 are carried by wings 16 of the aircraft 10. In other embodiments, the engines 14 may be carried by a fuselage 18 and/or an empennage 20. The empennage 20 may also support horizontal stabilizers 22 and a vertical stabilizer 24.

The fuselage 18 of the aircraft 10 defines an internal cabin, which may be defined by interior sidewall panels that connect to a ceiling and a floor. The internal cabin may include a cockpit, one or more work sections (for example, galleys, personnel carry-on baggage areas, and the like), one or more passenger sections (for example, first class, business class, and economy sections), and an aft section in which an aft rest area assembly may be positioned. Overhead stowage bin assemblies may be positioned throughout the internal cabin.

Alternatively, instead of an aircraft, embodiments of the present disclosure may be used with various other vehicles, such as automobiles, buses, locomotives and train cars, seacraft, spacecraft, and the like.

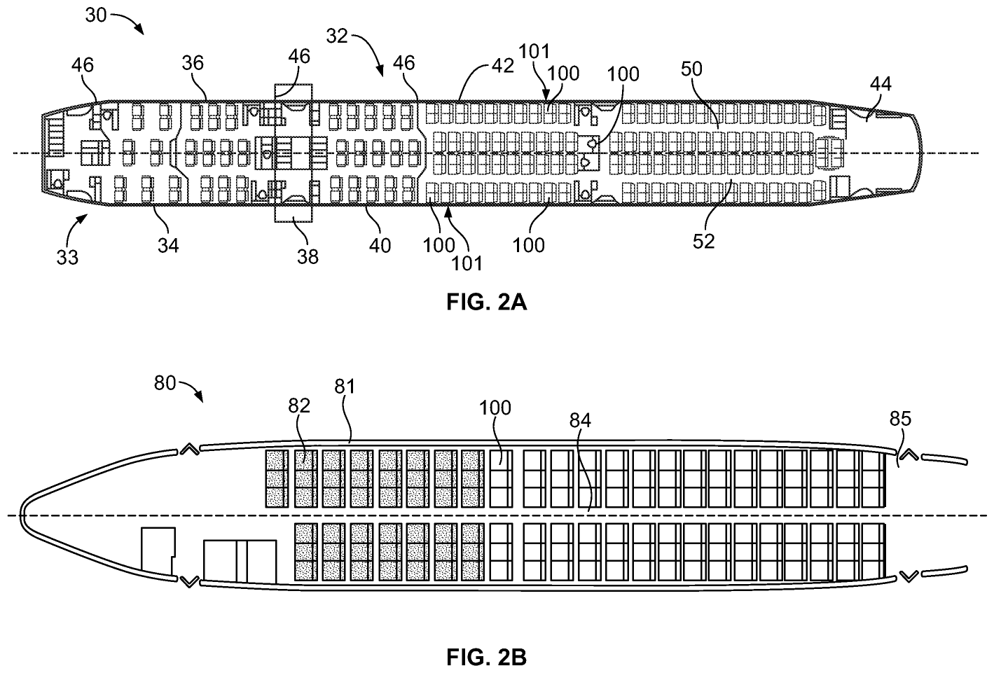

FIG. 2A illustrates a top plan view of an internal cabin 30 of an aircraft, according to an embodiment of the present disclosure. The internal cabin 30 may be within a fuselage 32 of the aircraft. For example, one or more fuselage walls may define an interior of the internal cabin 30. The interior of the internal cabin 30 is defined by sidewall panels that connect to a ceiling and a floor. The sidewall panels include lateral segments that connect to ceiling segments. The lateral segments define lateral wall portions, while the ceiling segments define at least portions of the ceiling within the internal cabin 30.

The internal cabin 30 includes multiple sections, including a front section 33, a first class section 34, a business class section 36, a front galley station 38, an expanded economy or coach section 40, a standard economy or coach section 42, and an aft section 44, which may include multiple lavatories and galley stations. It is to be understood that the internal cabin 30 may include more or less sections than shown. For example, the internal cabin 30 may not include a first class section, and may include more or less galley stations than shown. Each of the sections may be separated by a cabin transition area 46.

As shown in FIG. 2A, the internal cabin 30 includes two aisles 50 and 52 that lead to the aft section 44. Optionally, the internal cabin 30 may have less or more aisles than shown. For example, the internal cabin 30 may include a single aisle that extends through the center of the internal cabin 30 that leads to the aft section 44.

Seat assemblies 100 are positioned throughout the internal cabin 30. The seat assemblies 100 may be arranged in rows 101. The seat assemblies 100 form part of seat adjustment systems, as described herein, that allow spacing or pitch between rows 101 of adjacent seat assemblies 100 to be quickly and efficiently adjusted.

FIG. 2B illustrates a top plan view of an internal cabin 80 of an aircraft, according to an embodiment of the present disclosure. The internal cabin 80 may be within a fuselage 81 of the aircraft. For example, one or more fuselage walls may define the interior of the internal cabin 80. The internal cabin 80 includes multiple sections, including a main cabin 82 having passenger seat assemblies 100, and an aft section 85 behind the main cabin 82. It is to be understood that the internal cabin 80 may include more or less sections than shown.

The internal cabin 80 may include a single aisle 84 that leads to the aft section 85. The single aisle 84 may extend through the center of the internal cabin 80 that leads to the aft section 85. For example, the single aisle 84 may be coaxially aligned with a central longitudinal plane of the internal cabin 80.

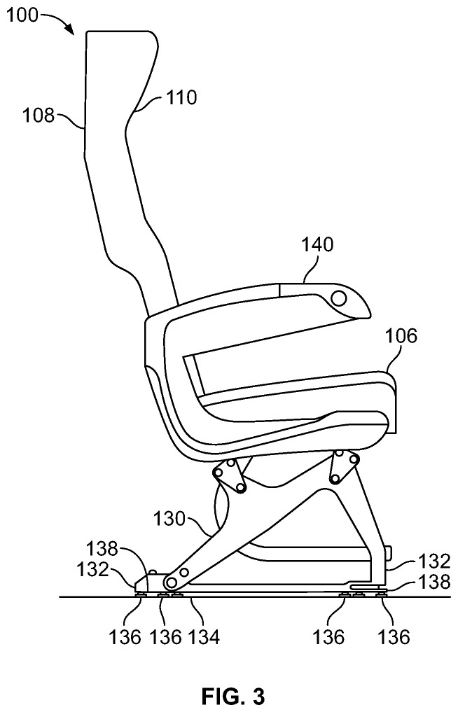

FIG. 3 illustrates a side view of a seat assembly 100, according to an embodiment of the present disclosure. The seat assembly 100 is configured to be secured within an internal cabin of a vehicle, such as a commercial aircraft.

The seat assembly 100 includes a base 130, which may include legs 132 that may be secured to seat tracks 134 within a cabin of a vehicle. In at least one embodiment, securing studs 136 (such as shear studs) downwardly extend from lower surfaces 138 of the legs 132. The securing studs 136 are securely retained within the seat tracks 134. The seat tracks 134 are configured to securely couple to the securing studs 136 to secure the seat assembly 100 in place. The base 130 supports a seat cushion 106 and a backrest 108, which includes a headrest 110. Arm rests 140 may be pivotally secured to the backrest 108.

The seat assembly 100 may be sized and shaped differently than shown in FIG. 3. The seat assembly 100 may include more or less components than shown in FIG. 3. It is to be understood that the seat assembly 100 shown in FIG. 3 is merely one example of a seat assembly that may be disposed within an internal cabin of a vehicle.

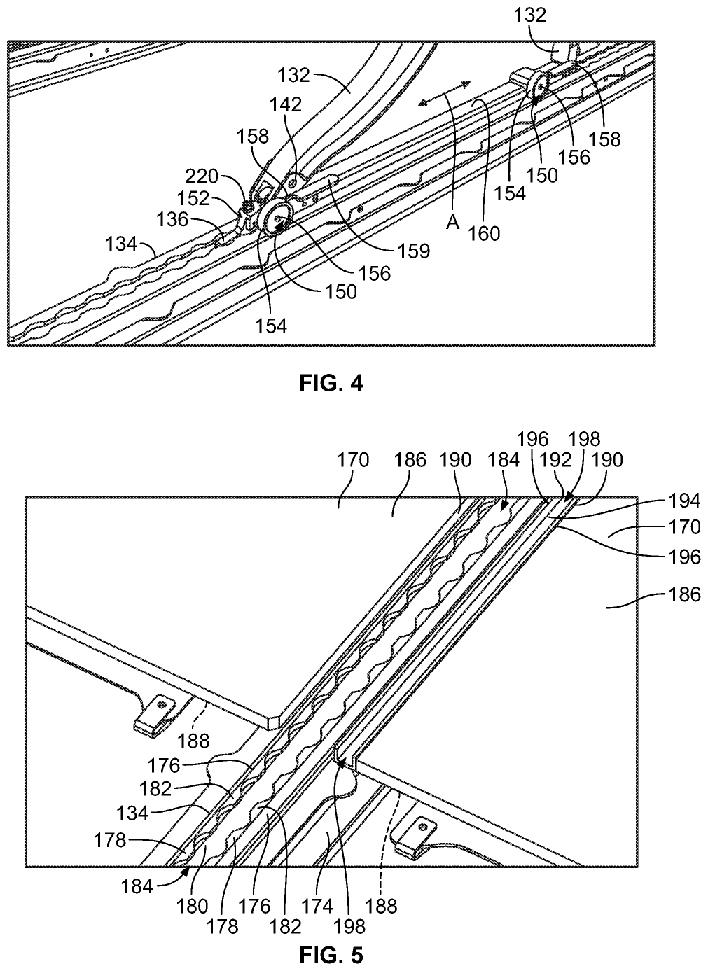

FIG. 4 illustrates a perspective side view of legs 132 of a seat assembly 100 securely coupled to a seat track 134, according to an embodiment of the present disclosure. Each leg 132 includes one or more securing studs 136 extending from a lower end 142. As shown in FIG. 4, the securing studs 136 are securely engaged by and coupled to the seat track 134.

A seat adjuster 150 is pivotally coupled to the leg 132. For example, the seat adjuster 150 is pivotally coupled to a bracket 152 that extends from the lower end 142 of the leg 132. The securing studs 136 downwardly extend from the bracket 152.

The seat adjuster 150 includes a wheel 154 that rotatably couples to a pivot beam 158 via a wheel axle 156 that passes through a reciprocal channel or bearing of the pivot beam 158. The pivot beam 158 is disposed between the bracket 152 and the wheel 154. The pivot beam 158 extends away from the wheel axle 156 and connects to a lever arm 159. The pivot beam 158 pivotally couples to the bracket 152 via a pivot axle 161.

As shown in FIG. 4, the seat adjuster 150 is in a secured position in which the lever arm 159 is generally disposed in a plane that is parallel to a plane of a top surface 160 of the seat track 134. In the secured position, the seat adjuster 150 positions the wheel 154 above the top surface of the seat track 134, and the wheel 154 is out of and positioned above a wheel track, as described herein.

Referring to FIGS. 3 and 4, each leg 132 of the seat assembly 100 may include a seat adjuster 150. Optionally, less than each leg 132 may include a seat adjuster 150. For example, only one leg 132 on each side of the seat assembly 100 may include a seat adjuster 150. In at least one other embodiment, only one leg 132 of the seat assembly 100 may include a seat adjuster 150.

FIG. 5 illustrates a perspective top view of the seat track 134 secured between floor panels 170, according to an embodiment of the present disclosure. The seat track 134 includes a base 174 and lateral walls 176 extending upwardly from the base 174. A retaining lip 178 inwardly extends from a top end of each lateral wall 176, such as at a ninety degree angle. The retaining lips 178 cooperate to form a series of expanded openings 180 and retaining arms 182 over a track channel 184. The expanded openings 180 and retaining arms 182 alternate over a length of the seat track 134. That is, two expanded openings 180 are separated by a retaining arm 182.

The floor panels 170 include upper planar support surfaces 186 opposite from lower surfaces 188. The upper planar surface surfaces 186 connect to the lower surfaces 188 at edges, such as interior edges 190.

A wheel track 192 extends parallel to one side of the seat track 134. The wheel track 192 may be secured to the seat track 134 and/or a floor panel 170. The wheel track 192 includes a lower wall 194 connected to opposed lateral walls 196 that may be perpendicular to the lower wall 194. The lower wall 194 and the lateral walls 196 define a wheel channel 198. In at least one embodiment, the wheel track 192 is at least as long as the seat track 134. Optionally, the wheel track 192 may not be as long as the seat track 134.

In at least one embodiment, the wheel track 192 is secured to an interior edge 190 of a floor panel 170. For example, a lateral wall 196 of the wheel track 192 may be secured to the interior edge 190 of the floor panel 170 such as via fasteners, adhesives, and/or the like.

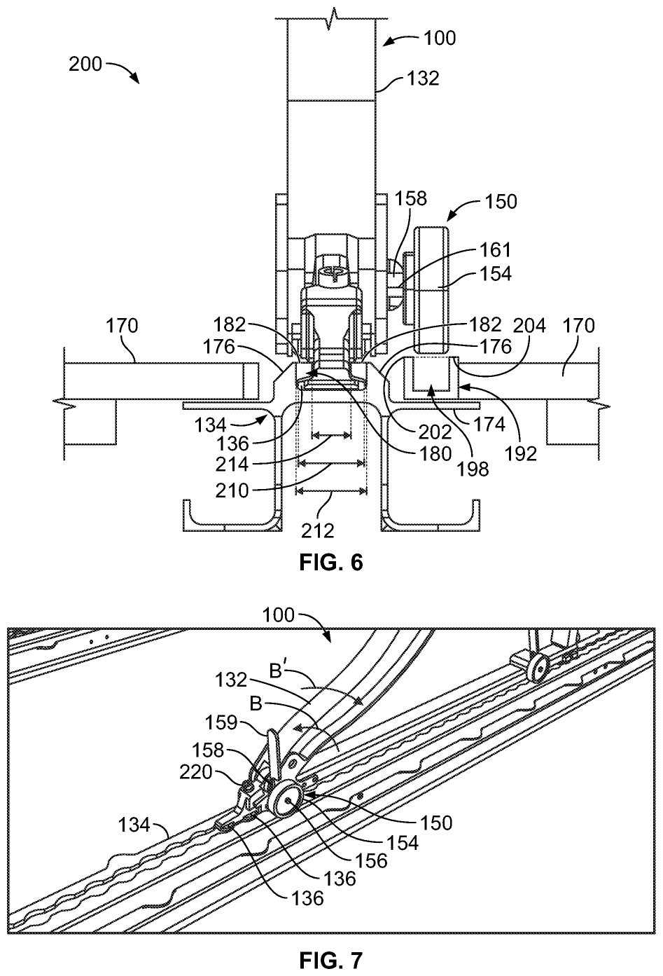

FIG. 6 illustrates an end view of seat adjustment system 200 having the seat adjuster 150 in the secured position, according to an embodiment of the present disclosure. In the secured position, the wheel 154 is out of the wheel channel 198 of the wheel track 192. That is, the wheel 154 is positioned above the wheel channel 198, and above a plane 202 in which upper edges 204 of the lateral walls 196 of the wheel track 192 reside. As shown, the lateral walls 196 may extend to a height that exceeds a height of the seat track 134.

The securing studs 136 of the seat assembly 100 may have a circular cross section and a width 210 that is less than a width 212 of the expanded openings 180. The width 210 is greater than a width 214 of the opening between opposed retaining arms 182. As such, when the securing studs 136 are positioned directly beneath the retaining arms 182, the securing studs 136 are locked in position, such that they are unable to eject through the opening between the retaining arms 182, thereby securely coupling the seat assembly 100 to the seat track 134. In contrast, when the securing studs 136 are shifted into the track channel 184 below or into the expanded openings 180, the securing studs 136, and therefore the legs 132 of the seat assembly 100, may be lifted out of the seat track 134.

Referring to FIGS. 3-6 (for clarity, the floor panels and the wheel track 192 are not shown in FIG. 4), in order to adjust the seat assembly 100 to a different longitudinal position, a lock fitting 220 (such as a bolt or other such fastener) is manipulated to unlock the legs 132. For example, the lock fitting 220 may be loosened such that a distal end no longer engages a portion of the seat track 134. Optionally, the seat assembly 100 may not include lock fittings.

After the lock fitting 220 disengages from the seat track 134, the seat assembly 100 may be longitudinally shifted in relation to the seat track 134 in the directions of arrows A. The seat assembly 100 is shifted in the direction of arrows A so that the securing studs 136 are no longer underneath the retaining arms 182, but are instead within the expanded openings 180. After the securing studs 136 are in the expanded openings 180, the seat adjuster 150 may be moved from the secured position (shown in FIGS. 4 and 6) to an adjustment position, as described herein.

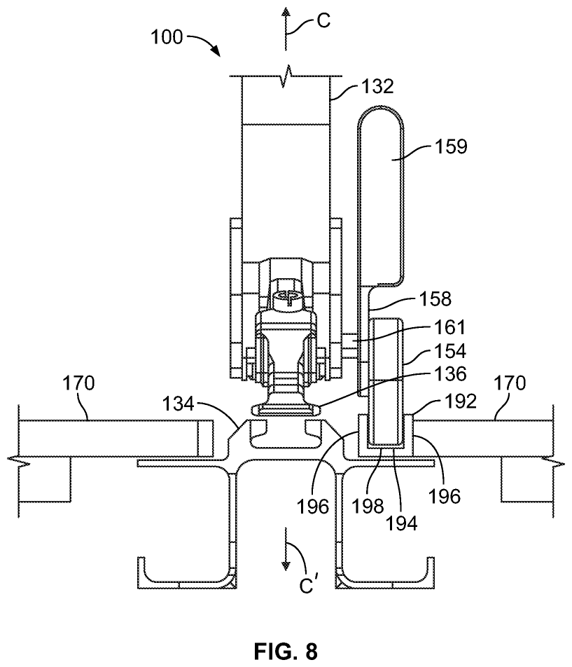

FIG. 7 illustrates a perspective side view of legs 132 of the seat assembly 100 uncoupled from the seat track 134, according to an embodiment of the present disclosure. FIG. 8 illustrates an end view of the seat adjustment system 200 having the seat adjuster 150 in an adjustment position, according to an embodiment of the present disclosure. Referring to FIGS. 7 and 8, in order to move the seat adjuster 150 from the secured position to the adjustment position, the lever arm 159 is upwardly pivoted in the direction of arc B about the pivot axle 161. In response, the wheel 154 is moved down into the wheel channel 198 of the wheel track 192. As the wheel 154 moves into the wheel channel 198 and exerts force into the lower wall 194 and/or the lateral walls 196 of the wheel track 192, the combined length of the lever arm 159, the pivot beam 158, and the wheel 154 causes the securing studs 136 to lift out of the seat track 134 in the direction of arrow C, so that the leg 132 uncouples from the seat track 134. The wheel 154 may then be rolled through the wheel track 192, thereby allowing the seat assembly 100 to be easily and smoothly moved to a desired position.

At the desired position, the securing studs 136 are positioned over desired expanded openings 180 (shown in FIG. 5). The lever arm 159 is then rotated back to the secured position in the direction of arc B′, thereby lifting the wheel 154 out of the wheel track 192, and causing the leg 132 to recede back into the seat track 134 in the direction of arrow C′. As such, the securing studs 136 are secured within the seat track 134 within the expanded openings 180. The seat assembly 100 is then longitudinally shifted in relation to the seat track 134 in the direction of arrow A so that the securing studs 136 are retained underneath opposed retaining arms 182 (shown in FIG. 5). The lock fitting 220 may then be manipulated to securely lock the legs 132 in place in relation to the seat track 134, and therefore lock the seat assembly 100 in position.

Referring to FIGS. 4-8, the lever arm 159 may be rotated ninety radial degrees in the direction of arc B to move the seat adjuster 150 from the secured position (shown in FIGS. 4 and 6), in which the seat assembly 100 is secured to the seat track 134, and the adjustment position (shown in FIGS. 7 and 8), in which the seat assembly 100 is uncoupled or disengaged from the seat track 134, and in which the seat assembly 100 may be slid to a desired position. Similarly, the lever arm 159 may be rotated ninety radial degrees in an opposite direction, such as in the direction of arc B′, to move the seat adjuster 150 from the adjustment position to the secured position. Optionally, the seat adjuster 150 may be configured to be selectively moved between the secured position and the adjustment position over less than ninety radial degrees.

Notably, in at least one embodiment, when the seat adjuster 150 is in the secured position, no part of the seat adjuster 150 may directly contact the floor panels 170, the wheel track 192, or the seat track 134. As such, in the secured position, the seat adjuster 150 may not be disposed within a load path of the seat assembly 100 when the seat assembly 100 is securely coupled to the seat track 134. Accordingly, the seat adjuster 150 may not be involved in or otherwise be considered during load path analysis for seat certification, such as determined by a regulatory body (for example, the United States Federal Aviation Administration). That is, the seat adjuster 150 may not form the basis for a renewed or additional load path analysis for seat certification.

As described herein, certain embodiments of the present disclosure provide a seat adjustment system 200 that includes a seat assembly 100 and a seat adjuster 150 coupled to the seat assembly 100. The seat assembly 100 includes at least one securing stud 136 that is configured to be retained by a seat track 134. The seat adjuster 150 is moveable between a secured position in which the securing stud(s) 136 is retained within the track channel 184 of the seat track 134, and an adjustment position in which the securing stud(s) 136 is outside of the seat track 134.

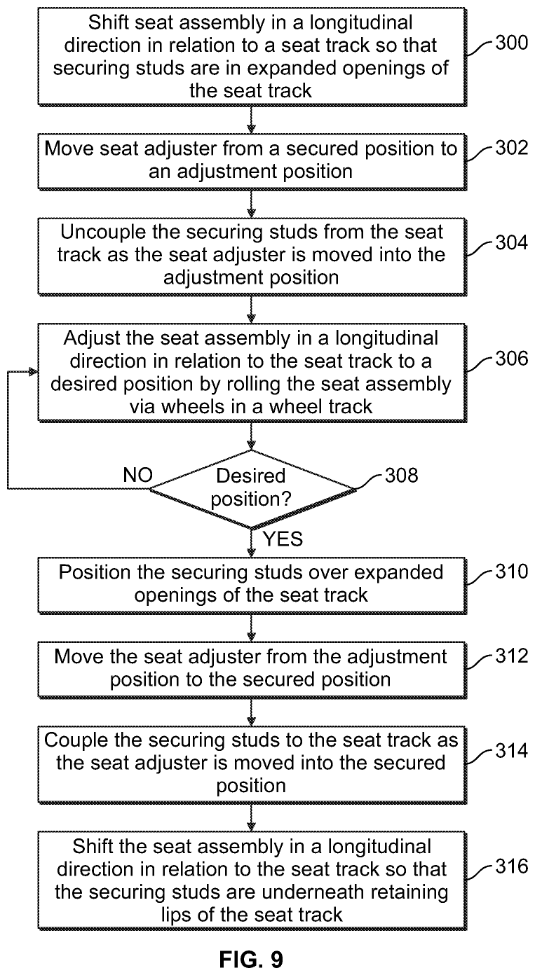

FIG. 9 illustrates a flow chart of a seat adjustment method, according to an embodiment of the present disclosure. Referring to FIGS. 4-9, at 300, the seat assembly 100 is shifted in a longitudinal direction in relation to the seat track 134 so that the securing studs 136 are in expanded openings 180 of the seat track 134. At 302, the seat adjuster 150 is moved from the secured position to the adjustment position. At 304, the securing studs 136 uncouple from the seat track 134 as the seat adjuster 150 is moved into the adjustment position.

At 306, the seat assembly 100 is adjusted in a longitudinal direction in relation to the seat track 134 to a desired position by rolling the seat assembly 100 via the wheels 154 of the seat adjuster 150 in the wheel track 192. At 308, it is determined if the seat assembly 100 is in a desired position. If not, the method returns to the 306.

If, however, the seat assembly 100 is at the desired position, the method proceeds from 308 to 310, at which the securing studs 136 of the legs 132 are positioned over expanded openings 180 of the seat track 134. Then, at 312, the seat adjuster 150 is moved from the adjustment position to the secured position. At 314, the securing studs 136 are coupled to the seat track 134 as the seat adjuster 150 is moved into the secured position. At 316, the seat assembly 100 may then be shifted in a longitudinal direction in relation to the seat track 134 so that the securing studs are trapped underneath the retaining arms 182 of the seat track 134.

As described herein, certain embodiments of the present disclosure provide a seat adjustment method that includes coupling a seat adjuster 150 to a seat assembly 100 having at least one securing stud 136 that is configured to be retained by a seat track 134. The method includes moving the seat adjuster between a secured position in which the securing stud(s) 136 is retained within the track channel 184 of the seat track 134, and an adjustment position in which the securing stud(s) 136 is outside of the seat track 134.

As explained herein, embodiments of the present disclosure provide efficient systems and methods for moving seats within an internal cabin of an aircraft. Further, embodiments of the present disclosure provide systems and methods that allow for quick and efficient adjustment of seats within an internal cabin.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A seat adjustment system, comprising:
a seat assembly having at least one securing stud that is configured to be retained within a track channel of a seat track; and
a seat adjuster coupled to the seat assembly,
wherein the seat adjuster is moveable between a secured position in which the at least one securing stud is configured to be retained within the track channel of the seat track, and an adjustment position in which the at least one securing stud is configured to be outside of the seat track.

2. The seat adjustment system of claim 1, wherein the at least one securing stud extends downwardly from at least one leg of the seat assembly.

3. The seat adjustment system of claim 1, wherein the seat adjuster is pivotally coupled to the seat assembly.

4. The seat adjustment system of claim 3, wherein the seat adjuster is pivotally coupled to a bracket that extends from a lower end of a leg of the seat assembly.

5. The seat adjustment system of claim 1, wherein the seat adjuster comprises:
a pivot beam pivotally coupled to the seat assembly;
a wheel rotatably coupled to the pivot beam via a wheel axle; and
a lever arm connected to the pivot beam.

6. The seat adjustment system of claim 5, wherein the wheel is retained within a wheel channel of a wheel track when the seat adjuster is in the adjustment position, and wherein the wheel is disposed above the wheel track when the seat adjuster is in the secured position.

7. The seat adjustment system of claim 6, wherein the wheel track extends along at least a portion of a length of the seat track.

8. The seat adjustment system of claim 6, wherein the wheel track is secured to one or both of the seat track or a floor panel.

9. The seat adjustment system of claim 6, wherein the lever arm is configured to be radially pivoted over a ninety degree radial range to move the seat adjuster between the secured position and the adjustment position.

10. The seat adjustment system of claim 1, wherein the at least one securing stud is shifted to an expanded opening within the seat track before the seat adjuster is moved to the adjustment position.

11. A seat adjustment method, comprising:
providing a seat assembly having at least one securing stud that is configured to be retained within a track channel of a seat track;
coupling a seat adjuster to the seat assembly; and
moving the seat adjuster between a secured position in which the at least one securing stud is retained within the track channel of the seat track, and an adjustment position in which the at least one securing stud is outside of the seat track.

12. The seat adjustment method of claim 11, wherein the coupling comprises pivotally coupling the seat adjuster to the seat assembly.

13. The seat adjustment method of claim 12, wherein the pivotally coupling comprises pivotally coupling the seat adjuster to a bracket that extends from a lower end of at least one leg.

14. The seat adjustment method of claim 11, wherein the coupling comprises:
pivotally coupling a pivot beam of the seat adjuster to the seat assembly;
rotatably coupling a wheel to the pivot beam via a wheel axle; and
connecting a lever arm to the pivot beam.

15. The seat adjustment method of claim 14, further comprising:
retaining the wheel within a wheel channel of a wheel track when the seat adjuster is in the adjustment position; and
disposing the wheel above the wheel track when the seat adjuster is in the secured position.

16. The seat adjustment method of claim 15, further comprising extending the wheel track along at least a portion of a length of the seat track.

17. The seat adjustment method of claim 15, further comprising securing the wheel track to one or both of the seat track or a floor panel.

18. The seat adjustment method of claim 15, wherein the moving comprises radially pivoting the lever arm over a ninety degree radial range to move the seat adjuster between the secured position and the adjustment position.

19. The seat adjustment method of claim 11, further comprising shifting the at least one securing stud to an expanded opening within the seat track before the seat adjuster is moved to the adjustment position.

20. A vehicle comprising:
an internal cabin;
a first floor panel within the internal cabin;
a second floor panel within the internal cabin;
a seat track extending between the first floor panel and the second floor panel, wherein the seat track comprises a track channel;
a wheel track having a wheel channel coupled to one or both of the first floor panel or the seat track, wherein the wheel track extends along at least a portion of a length of the seat track; and
a seat adjustment system, comprising:
a seat assembly having at least one securing stud that is configured to be retained within the track channel of the seat track; and
a seat adjuster pivotally coupled to the seat assembly, wherein the seat adjuster comprises a pivot beam pivotally coupled to the seat assembly, a wheel rotatably coupled to the pivot beam via a wheel axle, and a lever arm connected to the pivot beam,
wherein the seat adjuster is moveable between a secured position in which the at least one securing stud is retained within the track channel of the seat track, and an adjustment position in which the at least one securing stud is outside of the seat track,
wherein the wheel is retained within the wheel channel of the wheel track when the seat adjuster is in the adjustment position, and wherein the wheel is disposed above the wheel track when the seat adjuster is in the secured position.
